(19) United States
(12) Patent Application Publication
(10) Pub. No.: US 2016/0350003 A1
(43) Pub. Date: Dec. 1, 2016

(54) MEMORY SYSTEM

(71) Applicant: Kabushiki Kaisha Toshiba, Minato-ku (JP)

(72) Inventor: Shinichi KANNO, Ota (JP)

(73) Assignee: Kabushiki Kaisha Toshiba, Minato-ku (JP)

(21) Appl. No.: 15/018,097

(22) Filed: Feb. 8, 2016

(30) Foreign Application Priority Data
May 29, 2015 (JP) 2015-110461

(51) Int. Cl. G06F 3/06; G06F 12/10

(52) U.S. Cl. CPC G06F 3/0605; G06F 3/0659; G06F 3/0679; G06F 12/10; G06F 2212/1008; G06F 2212/152; G06F 2212/214; G06F 2212/657; G06F 2212/7201

(57) ABSTRACT

According to one embodiment, a memory system includes a nonvolatile memory and a controller. The controller executes data transfer between a host and the memory in response to a command from the host. The controller manages first translation information indicating a relation between logical location information and physical location information. In a case where the controller stores first data to the memory, the controller updates second translation information. The first data is included in a data group received from the host in a first write mode, and the second translation information is a copy of the first translation information. In a case where the first write mode is terminated, the controller reflects the second translation information in the first translation information.

### CROSS-REFERENCE TO RELATED APPLICATIONS

This application is based upon and claims the benefit of priority from Japanese Patent Application No. 2015-110461, filed on May 29, 2015; the entire contents of which are incorporated herein by reference.

### FIELD

Embodiments described herein relate generally to a memory system.

### BACKGROUND

In the past, a memory system using a NAND-type flash memory as a storage medium is known. The memory system manages translation information to which a relation between logical location information designated from the outside (a logical address) and location information indicating physical location in a storage medium (a physical address) is recorded.

In a case where a transfer error occurs in data which are requested to be written, the memory system may be requested to return back to a state immediately before the data which are requested to be written are started to be written. Such writing mode is expressed as atomic write (Atomic Write).

### BRIEF DESCRIPTION OF THE DRAWINGS

FIG. 1 is a figure illustrating an example of a configuration of a memory system according to a first embodiment;

FIG. 2 is a figure illustrating an example in which a write command of a mode of an atomic write is transmitted and received;

FIG. 3 is a figure schematically illustrating a processing unit of data in a NAND memory and a management unit of a location in the first embodiment;

FIG. 4 is a figure for explaining a region;

FIG. 5 is a figure for explaining a first table cache, a second table, and a second table cache;

FIG. 6 is a figure illustrating an example of a configuration of data of a second table;

FIG. 7 is a figure illustrating an example of a configuration of data of log information;

FIG. 8 is a flowchart for explaining an example of restoring processing;

FIG. 9 is a figure illustrating an example of a configuration of a memory system according to a second embodiment;

FIG. 10 is a figure for explaining a cache according to the second embodiment of the second table;

FIG. 11 is a flowchart for explaining an operation of a data processing unit according to the second embodiment;

FIG. 12 is a flowchart for explaining an operation of a management unit according to the second embodiment; and

FIG. 13 is a figure illustrating an example of an implementation of a memory system.

### DETAILED DESCRIPTION

In general, according to one embodiment, a memory system is connectable to a host. The memory system includes a nonvolatile memory and a controller. The controller executes data transfer between the host and the memory in response to a command from the host. The controller manages first translation information indicating a relation between logical location information and physical location information. The logical location information is location information designated from the host. The physical location information is location information indicating a physical location in the memory. In a case where the controller stores first data to the memory, the controller updates second translation information. The first data is included in a data group received from the host in a first write mode, and the second translation information is a copy of the first translation information. In a case where the first write mode is terminated, the controller reflects the second translation information in the first translation information.

Exemplary embodiments of a memory system will be explained below in detail with reference to the accompanying drawings. The present invention is not limited to the following embodiments.

### First Embodiment

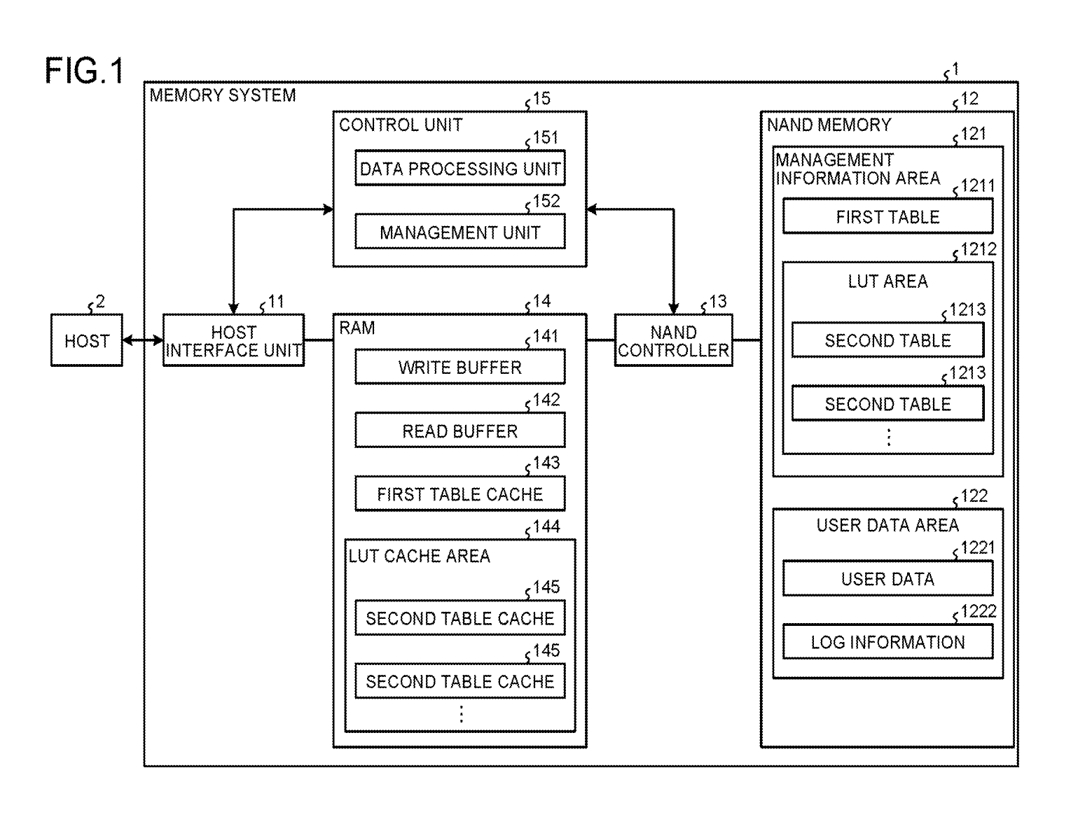

FIG. 1 is a figure illustrating an example of a configuration of a memory system according to the first embodiment. The memory system 1 is, for example, an SSD (Solid State Drive). Hereinafter, for example, a case where a NAND-type flash memory (hereinafter referred to as a NAND memory) is used as a nonvolatile memory will be explained.

The memory system 1 is configured to be connectable to a host 2. For example, a CPU (Central Processing Unit), a personal computer, a portable information device, a server, and the like correspond to the host 2. Any given interface standard can be employed as an interface standard of communication between the memory system 1 and the host 2. Two or more hosts 2 may be connected to the memory system 1 at a time. The host 2 and the memory system 1 may be connected via a network.

The memory system 1 executes transmission and reception of data to and from the host 2 in accordance with an access request from the host 2. The access request includes a write command and a read command. The access request includes address information logically indicating the access location. For example, an LBA (Logical Block Address) can be employed as the address information. For example, when NVMe is employed as the interface standard of communication between the memory system 1 and the host 2, the address information may include identification information of the name space and an LBA. The name space is a logical address space identified by the identification information of the name space. More specifically, in a case where NVMe is employed, the memory system 1 can manage multiple logical address spaces.

The memory system 1 can receive a write command of a mode of an atomic write from the host 2. The atomic write is one of the modes of writing. According to the mode of the atomic write, in a case where reception of user data, which are requested to be written, is interrupted in that mode, it is requested to return back to the state immediately before the data, which are requested to be written, are begun to be written in that mode. With regard to one or more user data (data group) requested to be written from when the mode of the atomic write is started to when the mode is ended, it is considered that, from the perspective of the host 2, either all the user data are written or even a single piece of the user data is not written.

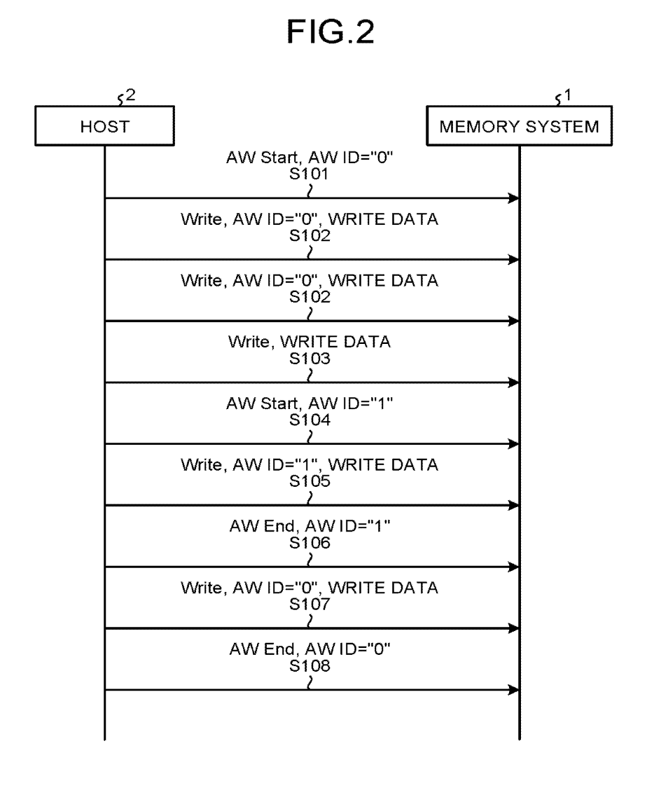

FIG. 2 is a figure illustrating an example in which a write command of the mode of the atomic write is transmitted and received. The mode of the atomic write will be denoted as an atomic write mode. Before the host 2 transmits a write command of the atomic write mode, the host 2 transmits a start command of the atomic write (S101). The atomic write ID (AW ID) is attached to the start command of the atomic write. The memory system 1 can execute the atomic write of multiple threads. More specifically, the memory system 1 can input multiple threads in parallel. Inputting multiple threads in parallel means that another thread is started before any given thread is terminated as shown in S101 to S108. The AW ID is identification information for distinguishing threads. The thread is a combination of multiple write commands of the atomic write mode, which are issued in the chronological order from when the atomic write is started to when the atomic write is terminated. In a case where multiple threads are input into the memory system in parallel, each thread is terminated individually. One of the multiple threads is requested to be terminated by an end command for terminating the one thread. More specifically, an end command is input for each data group. Each write command includes a single piece of write data. The data group includes one or more write data transferred by one or more write commands of the atomic write mode. Each write data included in a single data group is transferred by a write command which belongs to the same thread. Two write data transferred by write commands which belong to different threads belong to respectively different data groups.

It should be noted that the memory system 1 may be configured so that the thread is identified by information different from the AW ID. For example, a space, which is a target of the atomic write, may be designated by a logical address for each thread. For example, in a case where there is a limitation that two or more threads cannot be executed in a single name space, the thread can be identified by the identification information of the name space.

In S101, for example, the host 2 starts the thread of AW ID=“0”. The host 2 can transmit the write command of the atomic write mode, which belongs to the thread started by the start command, after the start command is transmitted (S102). The write command of the atomic write mode includes an AW ID. The memory system 1 can identify the thread, to which the write command belongs, on the basis of the AW ID included in the write command of the atomic write mode. The host 2 can transmit, between write commands of the atomic write mode, an ordinary write command, i.e., a write command which is not the atomic write mode (S103). A write command other than the atomic write mode does not include the AW ID. Alternatively, a write command other than the atomic write mode may include a null value (for example “NULL”) as the AW ID. The host 2 can transmit a start command for starting another thread before one thread is terminated (S104), and can transmit a write command of the other thread (S105). The write command of the other thread means a write command which belongs to another thread. In the processing of S105, before the thread of AW ID=“0” is terminated, the thread of AW ID=“1” is started. The host 2 can transmit an end command for terminating the thread of AW ID=“1” before terminating the thread of AW ID=“0” (S106). Since the end command includes the AW ID, the memory system 1 can recognize the thread to be terminated. It should be noted that the host 2 can also transmit the end command for terminating the thread of AW ID=“0” before the thread of AW ID=“1” is terminated. In the example of FIG. 2, the host 2 transmits the write command of the thread of AW ID=“0” again (S107), and thereafter, transmits the end command for terminating the thread of AW ID=“0” (S108). It should be noted that the start command or the end command may not be a command independent from the write command. For example, the start command or the end command may be prepared as a command option of the write command. The start command or the end command may be a flag that can be attached to the write command. The start command or the end command may be notified via a dedicated signal line. It should be noted that the start command and the end command may be abolished, and a command option indicating whether the write command is the write command of the atomic write mode or not may be prepared as a command option of the write command. A single end command may be input for predetermined multiple threads.

The memory system 1 includes a host interface unit 11, a NAND memory 12, a NAND controller 13, a RAM (Random Access Memory) 14, and a control unit 15.

The control unit 15 is realized by, for example, an FPGA (Field-Programmable Gate Array), an ASIC (Application Specific Integrated Circuit), or an arithmetic operation device such as a CPU (Central Processing Unit) and the like. The control unit 15 functions as a data processing unit 151 and a management unit 152 by executing a program stored at a predetermined location in the memory system 1 in advance. The storage location of the program is designed in any manner. For example, the program is stored to the NAND memory 12 in advance, and loaded to the RAM 14 during booting. The control unit 15 executes the program loaded to the RAM 14. Some or all of the functions of the data processing unit 151 may be achieved by hardware. Some or all of the functions of the management unit 152 may be achieved by hardware.

The data processing unit 151 executes data transfer between the host 2 and the NAND memory 12. In a case where the data processing unit 151 writes user data to the NAND memory 12, a writing log 1223 (explained later) corresponding to the user data is written to the NAND memory 12.

The management unit 152 executes the management of the management information. The management information includes translation information, statistics information, block information, and the like. The translation information is information in which a relation between a logical address and address information indicating a physical location in the NAND memory 12 (physical address) is recorded. The statistics information is information in which usage situation of the memory system 1, a power-ON time, the number of times of power-OFF, and the like are recorded. The block information is, for example, information in which, for each physical block (explained later), the number of times of rewriting, the number of effective data, and the like are recorded. The management unit 152 executes translation between the logical address and the physical address.

The management unit 152 executes processing for returning the translation information back to the state before the thread is started in a case where the thread is interrupted (hereinafter referred to as restoring processing). The interruption of the thread means a phenomenon in which all of the user data which are requested to be written by a series of write commands constituting the thread cannot be written to the NAND memory 12. For example, in a case where the memory system 1 is turned off during the reception of the thread, the thread is interrupted.

The host interface unit 11 is an interface device for communicating with the host 2. For example, the host interface unit 11 executes transfer of user data between the host 2 and the RAM 14 under the control of the data processing unit 151.

The NAND controller 13 is an interface device for accessing the NAND memory 12. The NAND controller 13 executes transfer of user data or management information between the RAM 14 and the NAND memory 12 under the control of the control unit 15. Although the details are omitted, the NAND controller 13 can perform error correction processing.

The NAND memory 12 is a nonvolatile storage medium functioning as a storage. The NAND memory 12 is constituted by one or more chips.

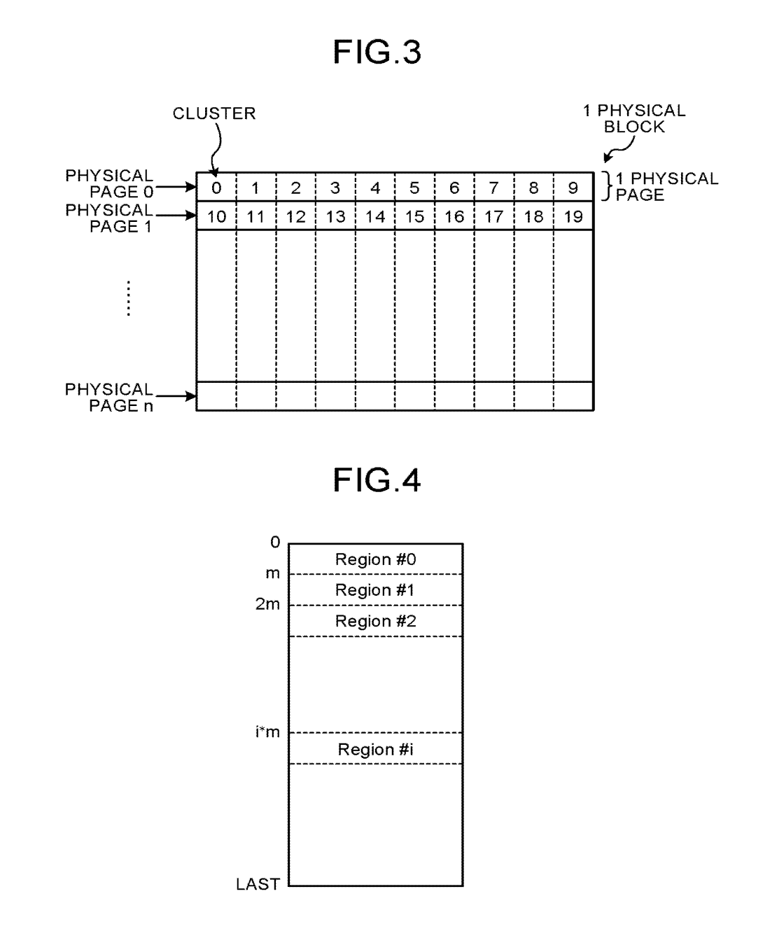

FIG. 3 is a figure schematically illustrating a processing unit of data and a management unit of a location in the NAND memory 12 according to the first embodiment. Inside of the chip constituting the NAND memory 12, the storage area of the data is composed of multiple physical blocks. Each physical block is composed of multiple physical pages. The physical page is a unit that can be accessed for writing and reading. Regarding the physical block, the minimum unit with which data can be erased at a time is the physical block.

For the storage area of the data, a physical address is allocated to a unit smaller than a single physical page. In this case, a unit to which a physical address is allocated is denoted as a cluster. The translation information is managed with a cluster unit. The size of a single cluster may be equal to the minimum access unit from the host 2, or may be different therefrom. In the example of FIG. 3, a single physical page is assumed to be constituted by 10 clusters. In the example of FIG. 3, a single physical block is assumed to be constituted by n (n is a natural number) physical pages.

The RAM 14 is a storage medium for temporarily storing data. For example, a kind of a storage medium which can be operated in a higher speed than the NAND memory 12 can be employed as the RAM 14. For example, a volatile or nonvolatile storage medium can be employed as the RAM 14. For example, a DRAM (Dynamic RAM), an SRAM (Static RAM), an FeRAM (Ferroelectric RAM), an MRAM (Magnetoresistive RAM), a PRAM (Phase change RAM), and the like can be employed as the RAM 14.

In the NAND memory 12, a management information area 121 and a user data area 122 are allocated. Each of the areas 121, 122 is constituted by, for example, multiple physical blocks. The user data area 122 stores one or more data (user data 1221) requested to be written by the host 2 and log information 1222. In the explanation about this case, the size of each user data 1221 is the size of the cluster.

The management information area 121 stores first table 1211. In the management information area 121, an LUT area 1212 storing one or more second tables 1213 is allocated. The LUT area 1212 is constituted by, for example, multiple physical blocks. The first table 1211 and one or more second tables 1213 constitute the translation information.

A write buffer 141, a read buffer 142, and an LUT cache area 144 are allocated in the RAM 14. The RAM 14 stores first table cache 143.

The write buffer 141 and the read buffer 142 are buffers for data transfer between the host 2 and the NAND memory 12. In the write buffer 141 and the read buffer 142, data are input and output in accordance with a rule of FIFO. The write buffer 141 stores user data received from the host 2 by the host interface unit 11. The user data stored in the write buffer 141 are written to the user data area 122 by the NAND controller 13. The read buffer 142 stores the user data 1221 read from the user data area 122 by the NAND controller 13. The user data 1221 stored in the read buffer 142 are transferred by the host interface unit 11 to the host 2.

The first table 1211 and one or more second tables 1213 are cached in the RAM 14, and updated on the RAM 14. The LUT cache area 144 is an area where the second tables 1213 are cached. The second table 1213 cached in the LUT cache area 144 will be denoted as a second table cache 145. The first table cache 143 is the first table 1211 cached in the RAM 14.

The translation information will be explained with reference to FIGS. 4, 5, and 6. The management unit 152 hierarchizes the translation information into two or more levels in the hierarchy. In this case, for example, the management unit 152 manages the translation information as a table group of two levels in the hierarchy. The first table 1211 and the first table cache 143 corresponds to a table of the first level in the hierarchy. One or more second tables 1213 and one or more second table caches 145 correspond to the table of the second level in the hierarchy.

The management unit 152 divides the logical address space into multiple partial spaces. The partial space is denoted as a region (Region). FIG. 4 is a figure for explaining a region. Each region includes multiple clusters in which the logical addresses are continuous. In this case, each region includes m (m is a natural number) clusters. Each region is identified by a region number (Region No.). The region number can be obtained by shifting, for example, a logical address in the right direction. The region #i is in a range from a logical address i*m to a logical address ((i+1)*m−1). An address in a region is expressed by an offset from the head of the region. Digits higher than a predetermined digit of a logical address corresponds to a region number, and digits lower than the predetermined digit of the logical address corresponds to an address in the region.

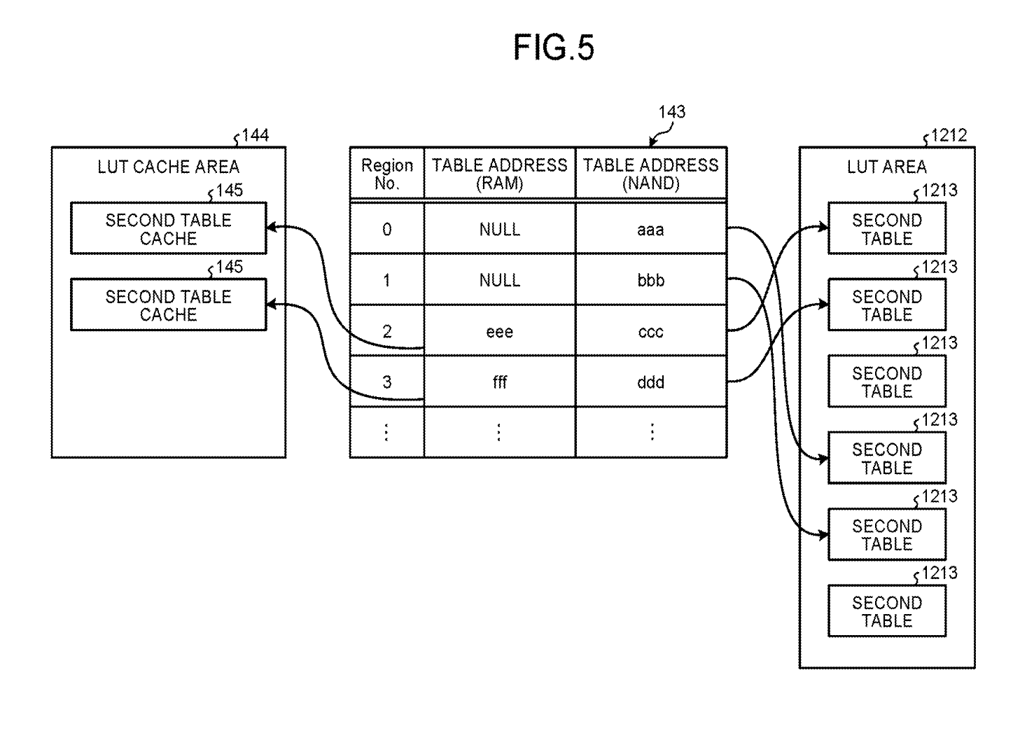

FIG. 5 is a figure for explaining the first table cache 143, the second tables 1213, and the second table caches 145. In the first table cache 143, a table address is recorded for each region. The table address is address information indicating the physical storage location of the second table 1213 or the second table cache 145. In this case, the first table cache 143 records, for each region, both of the table address in the RAM 14 indicating the storage location of the second table cache 145 and the table address in the NAND memory 12 indicating the storage location of the second table 1213. In a case where the second table cache 145 does not have a cache for any given region, a null value (for example “NULL”) is recorded as the table address of the storage location of the second table cache 145 corresponding to the given region. The management unit 152 can determine whether the second table cache 145 is cached for the given region or not on the basis of whether “NULL” is recorded as the table address in the RAM 14. It should be noted that the management as to whether the second table cache 145 is cached or not with regard to each region is not limited to the method explained above.

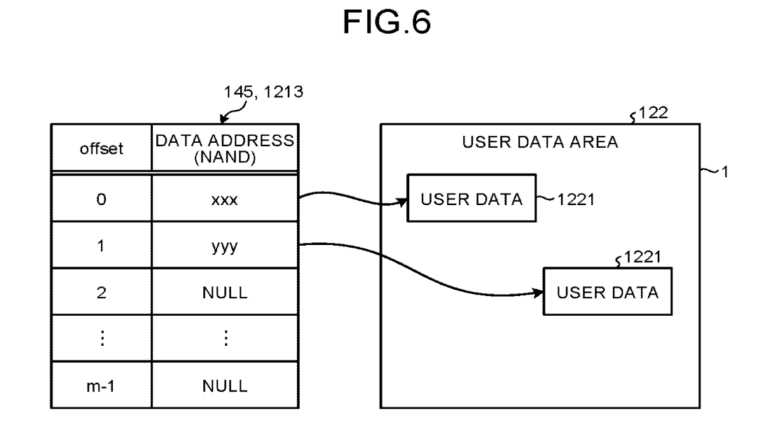

FIG. 6 is a figure illustrating an example of a configuration of data of the second table 1213. The second table 1213 and the second table cache 145 have, for example, the same data configuration. The second table 1213 records an address (data address) physically indicating the storage location of the user data 1221 for each address in the region. When each region is constituted by m clusters, the second table 145 includes at least m entries. A null value (for example “NULL”) is recorded in the second table 145 for a logical address that is not associated with a physical address.

The management unit 152 reads the translation information from the NAND memory 12 to the RAM 14, and uses the translation information read to the RAM 14. “Using the translation information” includes updating or referring to the translation information. For example, the management unit 152 reads all the entries of the first table 1211 to the RAM 14 as the first table cache 143. For example, the management unit 152 reads, to the LUT cache area 144, the second table 1213 including at least the entry of the target of the usage, from among one or more second tables 1213 stored in the LUT area 1212.

The management unit 152 updates the translation information read to the RAM 14, whereby the translation information stored in the RAM 14 is in the state different from translation information stored in the NAND memory 12. The state of the translation information stored in the RAM different from the translation information stored in the NAND memory 12 is denoted as dirty. The management unit 152 writes a dirty portion of the translation information to the NAND memory 12 with predetermined timing. When the dirty portion of the translation information is written to the NAND memory 12, the portion transits to the non-dirty state. The unit of the management as to whether the state is dirty or non-dirty is designed in any manner. For example, the management unit 152 manages whether each entry is dirty or non-dirty with regard to the first table cache 143. For example, the management unit 152 manages whether each second table cache 145 is dirty or non-dirty.

For example, when the user data are written from the write buffer 141 to the NAND memory 12, the data processing unit 151 transmits, with regard to the logical address indicating the location of user data, an update request for updating the relation between the logical address and the physical address to the management unit 152. The management unit 152 updates the second table cache 145 including the logical address designated by the update request on the basis of the update request. The management unit 152 manages, as dirty, the updated second table cache 145. The management unit 152 manages, as dirty, a record indicated by the dirty second table cache 145 in the records of the first table cache 143. After the management unit 152 writes the dirty second table cache 145 to the LUT area 1212, the management unit 152 manages the second table cache 145 as non-dirty. The management unit 152 updates a dirty record of the records of the first table cache 143 in accordance with writing of the second table cache 145 to the LUT area 1212, and thereafter, writes the updated record to the management information area 121. The management unit 152 writes the updated record to the management information area 121, and thereafter, manages the record as non-dirty.

The timing for writing a dirty portion of the translation information to the NAND memory 12 is designed in any manner. For example, the timing is determined on the basis of the total size of the dirty portion of the translation information. For example, some or all of the dirty portion are written to the NAND memory 12 with the timing when the total size of the dirty portion of the translation information becomes more than a predetermined threshold value. During power-OFF state, at least dirty portion of the translation information is written to the NAND memory 12. When the memory system 1 has a battery, the management unit 152 may be, during power-OFF state, driven by energy charged in the battery. During the power-OFF state, at least dirty portion of the translation information is written to the management information area 121. In a case where the NAND memory 12 includes an area for evacuating the management information in the emergency (emergency evacuation area) in addition to the management information area 121 and the user data area 122, at least the dirty portion of the translation information can be written to the emergency evacuation area. As described above, the management unit 152 manages the translation information in the RAM 14 so that the dirty portion of the translation information is not lost as much as possible.

It should be noted that the first table 1211 may have the same data configuration as the first table cache 143, or may have data configuration in which recording of the table address in the LUT cache area 144 is omitted.

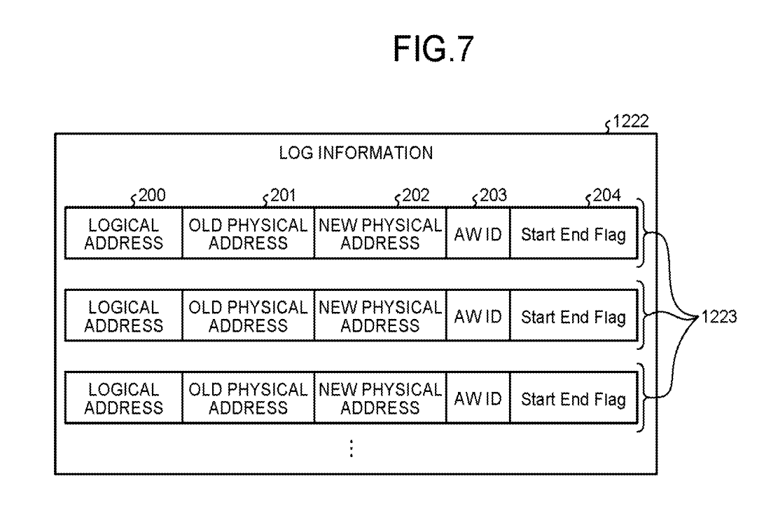

FIG. 7 is a figure illustrating an example of a configuration of data of the log information 1222. The log information 1222 includes one or more writing logs 1223. Each writing log 1223 is information indicating, using cluster units, a relation between the logical address and the physical address when the user data 1221 are written to the NAND memory 12. For example, a single piece of log information 1222 includes writing logs 1223 of all the clusters included in a single corresponding physical page. The log information 1222 corresponds to any one of the user data 1221. For example, the log information 1222 is written to a cluster at a predetermined location in each physical block (for example, a final cluster). In the present embodiment, information for returning the translation information back to the state before the user data which are requested to be written by the write command at the start of the thread are written to the NAND memory 12 in a case where the thread of the atomic write mode is interrupted is attached to the writing log 1223.

The writing log 1223 includes a logical address 200, an old physical address 201, a new physical address 202, an AW ID 203, and a Start End Flag 204. The old physical address 201 is a physical address associated with the logical address 200 before the user data 1221 are written. The new physical address 202 is a physical address newly associated with the logical address 200 when the corresponding user data 1221 are written. In other words, the new physical address 202 is a physical address indicating the location where the corresponding user data 1221 are written. The AW ID 203 is attached to the writing log 1223 of the user data 1221 requested to be written in the atomic write mode. The AW ID 203 is equal to the AW ID included in the write command of the atomic write mode. The Start End Flag 204 is a combination of a start flag indicating whether the user data 1221 is written to the start of the thread, and an end flag indicating whether the user data 1221 is written to the end of the thread. More specifically, the Start End Flag 204 has at least a size of 2 bits. The Start End Flag 204 is operated on the basis of the start command and the end command.

A case where user data which are requested to be written by a write command other than the atomic write mode are written from the write buffer 141 to the NAND memory 12 will be hereinafter explained. The data processing unit 151 writes the logical address 200, the old physical address 201, and the new physical address 202 to the writing log 1223. The data processing unit 151 does not use the AW ID 203 and the Start End Flag 204. For example, the data processing unit 151 records a null value (such as “NULL”) to the AW ID 203. The data processing unit 151 sets neither the start flag nor the end flag in the Start End Flag 204.

A case where the user data which are requested to be written by the write command of the atomic write mode are written from the write buffer 141 to the NAND memory 12 will be hereinafter explained. The data processing unit 151 records not only the logical address 200, the old physical address 201, and the new physical address 202 but also the AW ID 203 to the writing log 1223. The data processing unit 151 sets a start flag in the Start End Flag 204 of the writing log 1223 for user data which are requested to be written by the write command at the start of each thread. The data processing unit 151 sets an end flag in the Start End Flag 204 of the writing log 1223 for user data which are requested to be written by the write command at the end of each thread. The data processing unit 151 sets neither a start flag nor an end flag in the Start End Flag 204 for user data which are requested to be written by a write command that corresponds to neither the write command at the start of each thread nor the write command at the end of each thread from among the write commands belong to each thread.

For example, the end command is stored in the write buffer 141 by the data processing unit 151. When the user data which are requested to be written by the write command of the atomic write mode are written to the NAND memory 12, the data processing unit 151 refers to the write buffer 141 to determine whether an end command has been received, after the user data of the writing target, without any reception of user data which are requested to be written by a write command of the same thread as the user data of the writing target. In a case where an end command is determined to have been received without any reception of user data which are requested to be written by a write command of the same thread as the user data of the writing target, the data processing unit 151 determines that the user data of the writing target are user data which are requested to be written by a write command at the end of the thread.

In a case where a thread is interrupted, and there exists user data which are requested to be written by a write command of the interrupted thread and have already been written to the NAND memory 12, the physical address indicating the storage location of the user data is changed by the restoring processing from the state of associated with the logical address to the state of not being associated with the logical address. The user data of the state not associated with the logical address cannot be access from the host 2. Therefore, from the perspective of the host 2, the user data transmitted to the memory system 1 before the thread is interrupted appear to be not written to the NAND memory 12. More specifically, in a case where the thread is interrupted, the memory system 1 appears to have returned back to the state before the thread is started from the perspective of the host 2, and therefore the operation of the atomic write is realized.

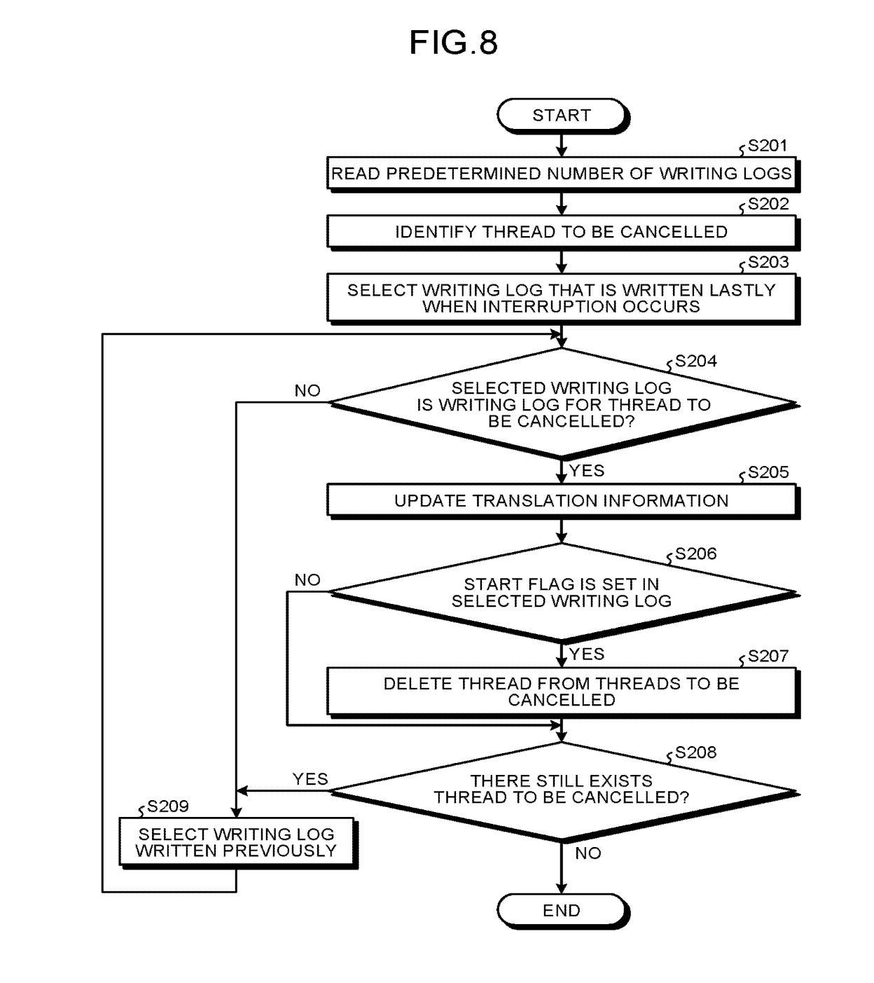

FIG. 8 is a flowchart for explaining an example of restoring processing. First, the management unit 152 restores, to the RAM 14, the first table cache 143 at the time of occurrence of the interruption of the thread.

Subsequently, the management unit 152 reads, in the order opposite to the order of writing, a predetermined number of writing logs 1223 from the writing logs 1223 written lastly when the interruption occurred (S201). The management unit 152 identifies a thread to be cancelled, on the basis of the predetermined number of writing logs 1223 having been read (S202).

More specifically, for example, the management unit 152 extracts all the AW IDs from the predetermined number of writing logs 1223 having been read. For example, in a case where the predetermined number of writing logs 1223 having been read include the writing log 1223 recorded with the AW ID=“0”, the writing log 1223 recorded with the AW ID=“1”, and the writing log 1223 recorded with the AW ID=“2”, the management unit 152 extracts AW ID=“0”, AW ID=“1”, and AW ID=“2”. Then, the management unit 152 searches a writing log 1223 having the end flag from the predetermined number of writing logs 1223 having been read. In a case where the writing log 1223 having the end flag is obtained, the management unit 152 obtains the AW ID recorded in the writing log 1223 having the end flag. By excluding the AW ID recorded in the writing log 1223 having the end flag, the AW ID indicating the interrupted thread is obtained. The management unit 152 identifies the interrupted thread as the thread to be cancelled.

After the processing of S202, the management unit 152 selects a writing log 1223 that is written lastly when the interruption occurred (S203). Then, the management unit 152 determines whether the selected writing log 1223 is a writing log 1223 for a thread to be cancelled or not (S204). The determination as to whether the selected writing log 1223 is a writing log 1223 for an interrupted thread or not can be determined on the basis of whether the AW ID 203 recorded in the selected writing log 1223 is included in any one of the AW IDs indicating the interrupted thread.

In a case where the selected writing log 1223 is a writing log 1223 for a thread to be cancelled (S204, Yes), the management unit 152 obtains the logical address 200 and the old physical address 201. Then, the management unit 152 changes the physical address associated with the obtained logical address 200 in the translation information to the obtained old physical address 201 (S205).

For example, the management unit 152 obtains, by referring to the restored first table cache 143, the storage location of the second table 1213 in which the relation of the obtained logical address 200 is recorded. Then, the management unit 152 reads the second table 1213 from the obtained storage location, and stores the second table 1213 having been read to the LUT cache area 144 as the second table cache 145. The management unit 152 updates the first table cache 143 in accordance with the storing of the second table cache 145 to the LUT cache area 144. Then, the management unit 152 executes the change in the second table cache 145 on the basis of the processing of S205. The management unit 152 manages, as dirty, the second table cache 145 changed in the processing of S205. The management unit 152 manages, as dirty, one of the records in the first table cache 143 that indicates the second table cache 145 changed in the processing of S205.

Subsequent to the processing of S205, the management unit 152 determines whether a start flag is set in the selected writing log 1223 or not (S206). In a case where a start flag is set in the selected writing log 1223 (S206, Yes), the management unit 152 deletes the thread indicated by the AW ID 203 recorded in the selected writing log 1223 from the threads to be cancelled (S207). In a case where a start flag is not set in the selected writing log 1223 (S206, No), or after the processing of S207, the management unit 152 determines whether there still exists a thread to be cancelled (S208).

In a case where the selected writing log 1223 is not a writing log 1223 for a thread to be cancelled (S204, No), or in a case where a thread to be cancelled still exists (S208, Yes), the management unit 152 newly selects a writing log 1223 written before the currently selected writing log 1223 (S209), and executes the processing of S204 for the newly selected writing log 1223. In a case where there does not exist any thread to be cancelled (S208, No), the management unit 152 terminates the restoring processing.

As described above, according to the first embodiment, every time the data processing unit 151 writes user data to the NAND memory 12, the data processing unit 151 records the writing log 1223. In addition, the data processing unit 151 records the start of the atomic write and the end of the atomic write to the writing log 1223. In a case where the thread is interrupted, the management unit 152 reads the writing log 1223 in the order opposite to the order of writing, whereby the translation information is returned back to the state before the thread is interrupted. Therefore, the operation of the atomic write is realized.

According to the above explanation, regardless of whether the write command for requesting writing of the user data is the write command of the atomic write mode or a write command other than the atomic write mode, the data processing unit 151 issues an update request when the user data are written to the NAND memory 12. In a case where the write command for requesting writing of the user data is the write command of the atomic write mode, the data processing unit 151 may queue the update request in the inside, and may transmit the update request queued inside to the management unit 152 after the reception of the end command is confirmed. Therefore, after the thread is finished, the translation information is updated, and therefore, the operation of the atomic write is realized without performing the restoring processing.

According to the above explanation, management unit 152 manages the translation information in the RAM 14, so that the dirty portion of the translation information is not lost as much as possible. In a case where the dirty portion of the translation information is lost, the management unit 152 restructures the translation information by referring to, for example, the writing logs 1223 in the order opposite to the order of writing. When the management unit 152 restructures the translation information, the management unit 152 identifies the thread to be cancelled, and reads the writing logs 1223 in the order opposite to the order of writing. In a case where a writing log 1223 other than a writing log 1223 for a thread to be cancelled is read out, and the logical address 200 of the writing log 1223 is associated with none of the physical addresses in the translation information, the management unit 152 records a relation between the logical address 200 recorded in the writing log 1223 and the new physical address 202 recorded in the writing log 1223 to the translation information in an overwriting format. In a case where a writing log 1223 for a thread to be cancelled is read out, the management unit 152 reads a subsequent writing log 1223. The management unit 152 restructures the translation information by performing the above processing on the writing logs 1223 successively read out.

### Second Embodiment

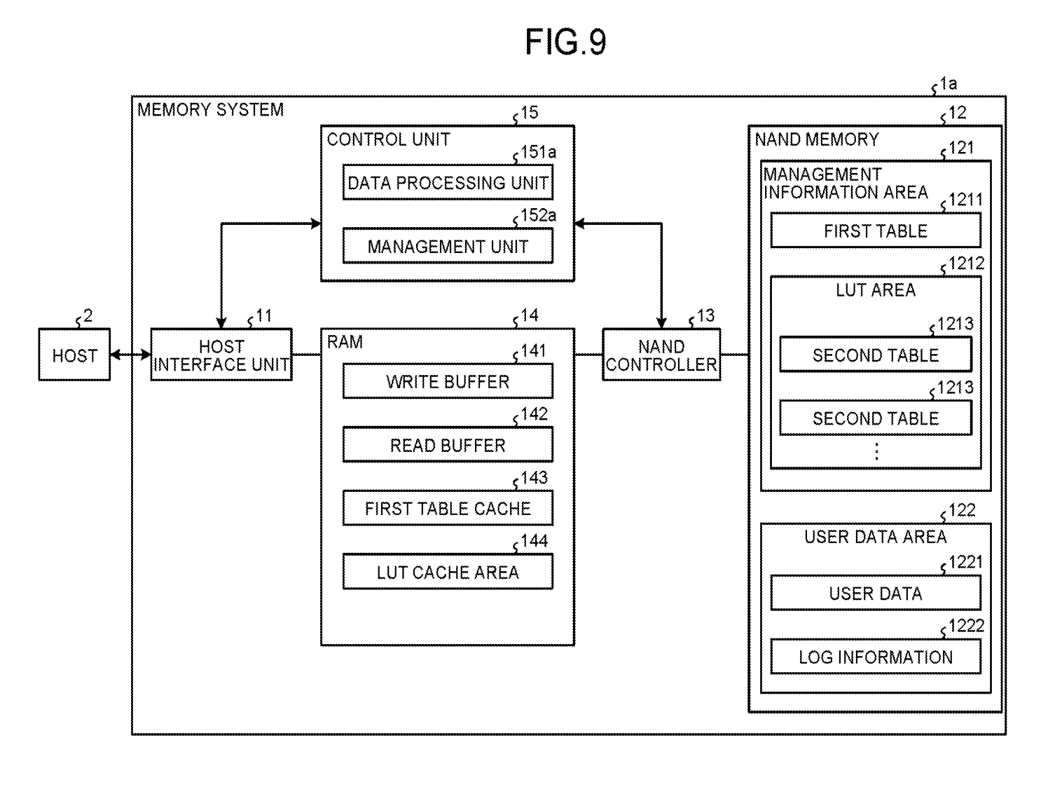

FIG. 9 is a figure illustrating an example of a configuration of a memory system according to the second embodiment. It should be noted that the constituent elements having the same functions as those of the first embodiment will be denoted with the same names and reference numerals as those of the first embodiment. Explanation about the constituent elements having the same functions as those of the first embodiment will be omitted.

The memory system 1a can be connected to the host 2. The memory system 1a may be configured to be connectable to multiple hosts 2. Like the memory system 1 of the first embodiment, the memory system 1a can receive the write command of the atomic write mode from the host 2. The memory system 1a includes a host interface unit 11, a NAND memory 12, a NAND controller 13, a RAM 14, and a control unit 15. The control unit 15 functions as a data processing unit 151a and a management unit 152a executes a program stored at a predetermined location in the memory system 1a in advance.

The data processing unit 151a executes data transfer between the host 2 and the NAND memory 12. The management unit 152a executes the management of the management information. The management information includes translation information, statistics information, block information, and the like. The management unit 152a executes the translation between the logical address and the physical address. The management unit 152a manages the translation information in the RAM 14, so that the dirty portion of the translation information is not lost as much as possible.

In the NAND memory 12, the management information area 121 and the user data area 122 are allocated. In the user data area 122, one or more user data 1221 and the log information 1222 are stored. In the second embodiment, the log information 1222 may not be recorded. The management information area 121 stores the first table 1211. In the management information area 121, the LUT area 1212 storing one or more second tables 1213 is allocated. The write buffer 141, the read buffer 142, and the LUT cache area 144 are allocated in the RAM 14. The RAM 14 stores the first table cache 143. The LUT cache area 144 stores the second tables 1213.

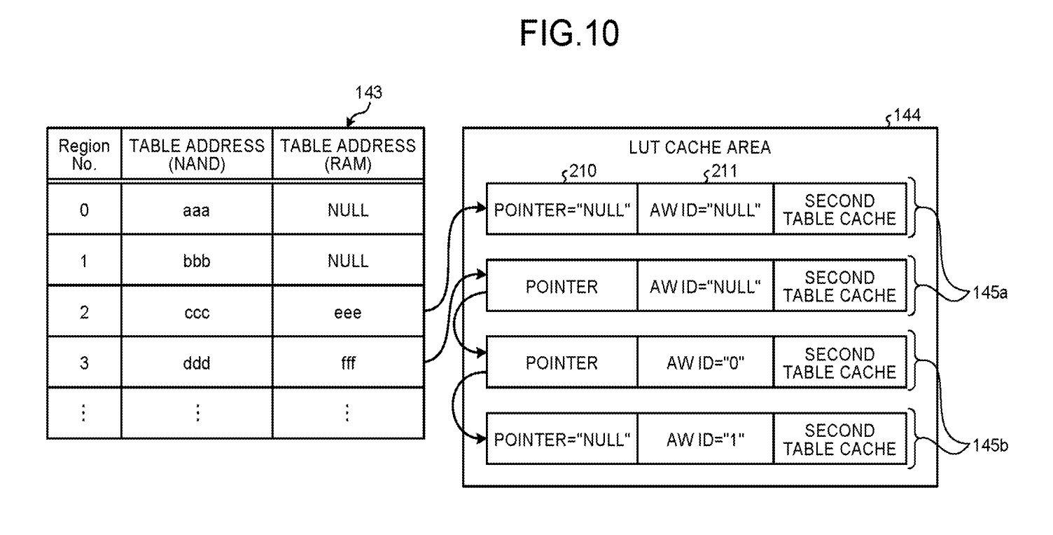

FIG. 10 is a figure for explaining a cache of the second embodiment of the second table 1213. In the second embodiment, the second table 1213 of each region can be cached as a single second table cache 145a. The second table 1213 of each region can be cached as a single second table cache 145a, and at the same time, can also be cached as one or more second table caches 145b. Each second table cache 145b is generated by copying the second table cache 145a of the corresponding region. “Copy” means generating data of the same content as the original data (copy source). The data generated by copying the copy source may be denoted as a copy. It should be noted that there may be a slight difference in, for example, a data format and the like, between the copy source and the copy. It should be noted that the number of second table caches 145b of a certain region is equal to the number of threads requiring the use of the second table 1213 of the region. More specifically, the second table cache 145b is cached for each thread.

The second table cache 145a and the second table cache 145b record a pointer 210 and an AW ID 211. The AW ID 211 of the second table cache 145b indicates the thread requiring the use of the second table cache 145b.

The storage location of the second table cache 145a is indicated by the first table cache 143. The storage location of the second table cache 145b is not indicated in the first table cache 143. The pointer 210 configures, from the second table cache 145a, the list structure for referring the storage locations of one or more second table caches 145b, which are the copies of the second table cache 145a. More specifically, in a case where there are one or more second table caches 145b which are the copies of the second table cache 145a, the pointer 210 of the second table cache 145a indicates the storage location of any given second table cache 145b of one or more second table caches 145b. In a case where there is no other second table cache 145b, the pointer 210 of the given second table cache 145b is recorded with a value indicating the end of the list structure (for example “NULL”). In a case where there are one or more other second table caches 145b, the pointer 210 of the given second table cache 145b indicates the storage location of any given second table cache 145b of one or more other second table caches 145b. In a case where there does not exist any second table cache 145b which is the copy of the second table cache 145a, the pointer 210 of the second table cache 145a records, for example, a value indicating the end of the list structure.

It should be noted that the method of the management of the relation between the second table cache 145a and one or more second table caches 145b which are the copies of the second table cache 145a is not limited to the method of the management using the list structure of the pointer 210. The relation of the second table cache 145a and one or more second table caches 145b which are the copies of the second table cache 145a may be managed by using a table separately provided. A dedicated entry may be provided in the first table cache 143, and a relation between the second table cache 145a and one or more second table caches 145b which are the copies of the second table cache 145a may be managed by the dedicated entry. The pointer 210 may be a bi-directional pointer.

When the user data which are requested to be written are written to the NAND memory 12 by the write command of the atomic write mode, the management unit 152a uses the second table cache 145b of the corresponding thread. When user data which are requested to be written by a write command other than the atomic write mode are written to the NAND memory 12, or when the user data are read from the NAND memory 12, the management unit 152a uses the second table cache 145a.

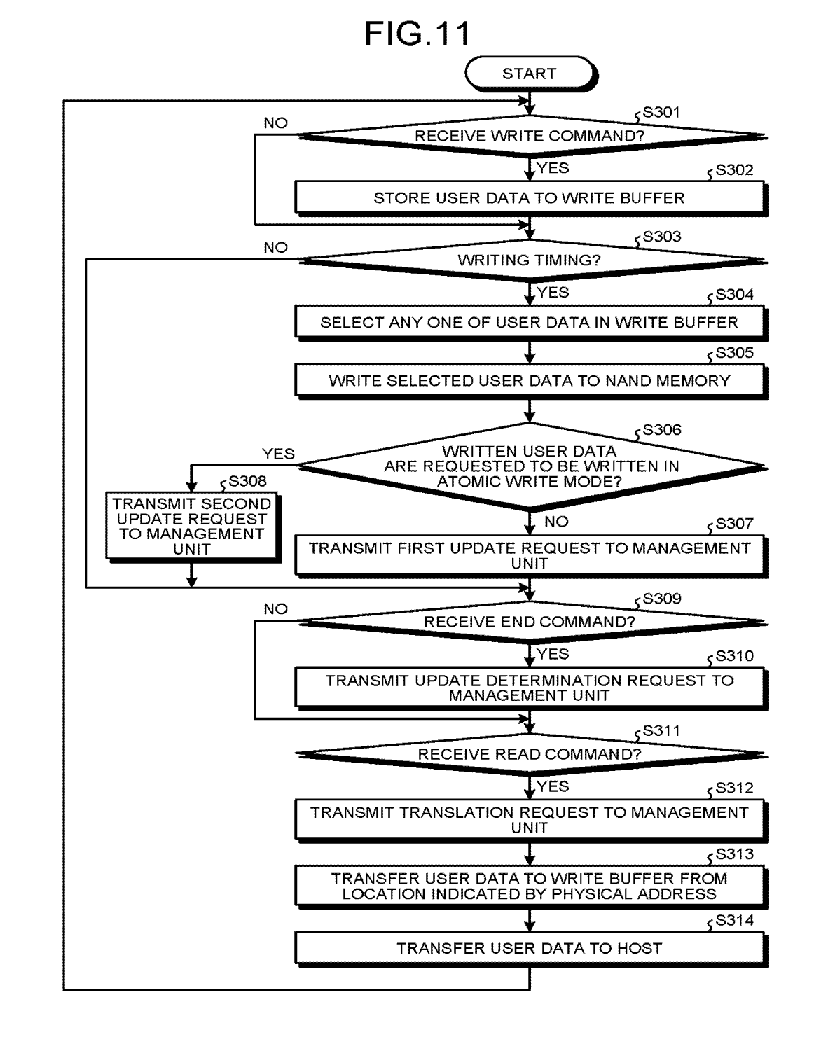

FIG. 11 is a flowchart for explaining an operation of the data processing unit 151a according to the second embodiment. The data processing unit 151a determines whether the write command has been received or not (S301). In a case where the write command is determined to have been received (S301, Yes), the data processing unit 151a stores, to the write buffer 141, the user data which are requested to be written by the write command (S302). In a case where the write command is not received (S301, No), the data processing unit 151a skips the processing of S302.

Subsequently, the data processing unit 151a determines whether writing timing has been reached or not (S303). Any given timing can be set as the writing timing. For example, the writing timing is determined on the basis of the total size of the user data stored in the write buffer 141. For example, the writing timing is timing when the total size of the user data stored in the write buffer 141 becomes more than a predetermined threshold value. For example, the writing timing is the timing when a Flush command has been received from the host 2. The Flush command is a command for writing, to the NAND memory 12, all the user data that are stored to the write buffer 141 and have not yet written to the NAND memory 12.

When the writing timing has been reached (S303, Yes), the data processing unit 151a selects one of the user data from the write buffer 141 (S304). The data processing unit 151a writes the selected user data to the NAND memory (S305). The data processing unit 151a determines whether the written user data are user data which are requested to be written by the write command of the atomic write mode or not (S306). In a case where the written user data are determined not to be the user data which are requested to be written by the write command of the atomic write mode (S306, No), the data processing unit 151a transmits the first update request to the management unit 152a (S307). In a case where the written user data are determined to be the user data which are requested to be written by the write command of the atomic write mode (S306, Yes), the data processing unit 151a transmits a second update request to the management unit 152a (S308).

The first update request and the second update request are requests for updating the translation information. The first update request includes at least the logical address, the old physical address, and the new physical address. The logical address included in the first update request is a logical address designated by the write command for requesting writing of the user data. The old physical address is a physical address associated with the logical address included in the first update request before the user data are written. The new physical address is a physical address newly associated with the logical address when the user data are written.

The second update request includes at least not only the logical address, the old physical address, and the new physical address but also the AW ID. The AW ID included in the second update request indicates a thread to which the write command for requesting writing of the written user data belongs.

When the writing timing has not yet been reached (S303, No), or after the processing of S307 or the processing of S308, the data processing unit 151a determines whether the end command has been received or not (S309). In a case where the end command is determined to have been received (S309, Yes), the data processing unit 151a transmits an update determination request to the management unit 152a (S310).

The update determination request is a request for reflecting the second table cache 145b corresponding to the thread terminated by the end command in the second table cache 145a which is the copy source of the second table cache 145b. The update determination request includes at least the AW ID indicating the thread terminated by the end command. It should be noted that the data processing unit 151a transmits the second update request of all the write data which are requested to be written by the write command of the thread identified by the AW ID included in the end command, and thereafter, transmits the update determination request.

In a case where the end command is not received (S309, No), or after the processing of S310, the data processing unit 151a determines whether a read command has been received or not (S311). In a case where the read command is determined to have been received (S311, Yes), the data processing unit 151a transmits a translation request to the management unit 152a (S312). The translation request includes at least the logical address designated by the read command. The management unit 152a translates the logical address included in the translation request, and returns the physical address obtained from the translation back to the data processing unit 151a. The data processing unit 151a reads the user data from the location indicated by the returned physical address to the write buffer 141 (S313). The data processing unit 151a transmits the user data, which have been read to the write buffer 141, to the host 2 (S314). After the processing of S314, the data processing unit 151a executes the processing of S301 again.

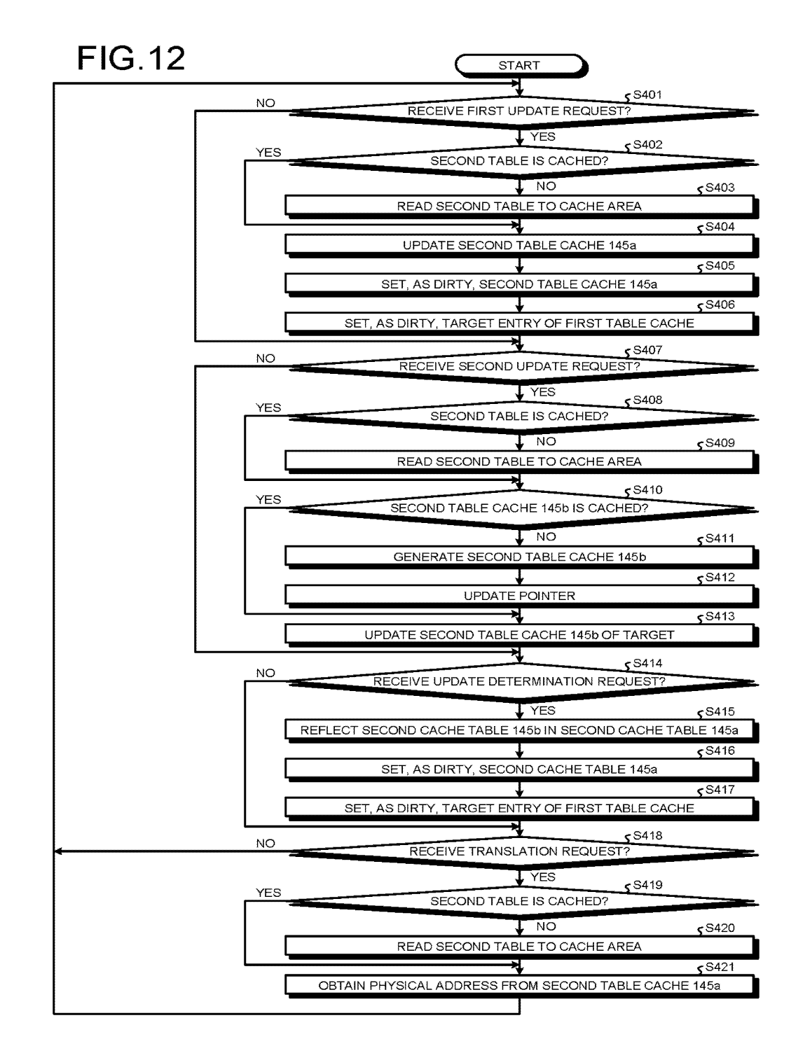

FIG. 12 is a flowchart for explaining an operation of the management unit 152a according to the second embodiment. The management unit 152a determines whether a first update request has been received or not (S401). In a case where the first update request is determined to have been received (S401, Yes), the management unit 152a determines whether the second table 1213 of the logical address included in the first update request is cached in the LUT cache area 144 or not (S402). In a case where the second table 1213 is determined not to be cached in the LUT cache area 144 (S402, No), the management unit 152a reads the second table 1213 to the LUT cache area 144 as the second table cache 145a (S403). The management unit 152a records “NULL” to the pointer 210 and the AW ID 211 of the second table cache 145a.

In a case where the second table 1213 is determined to be cached in the LUT cache area 144 (S402, Yes), or after the processing of S403, the management unit 152a updates the second table cache 145a (S404). More specifically, the management unit 152a associates the new physical address included in the first update request with the logical address included in the first update request. After the processing of S404, the management unit 152a sets, as dirty, the updated entry of the second table cache 145a (S405). In addition, in the first table cache 143, an entry indicating the storage location of the updated second table cache 145a is set as dirty (S406).

In a case where the first update request is not received (S401, No), or after the processing of S406, the management unit 152a determines whether the second update request has been received or not (S407). In a case where the second update request is determined to have been received (S407, Yes), the management unit 152a determines whether the second table 1213 for translation of the logical address included in the second update request is cached in the LUT cache area 144 or not (S408). In a case where the second table 1213 is determined not to be cached in the LUT cache area 144 (S408, No), the management unit 152a reads the second table 1213 as the second table cache 145a to the LUT cache area 144 (S409). The management unit 152a records “NULL” to the pointer 210 and the AW ID 211 of the second table cache 145a.

In a case where the second table 1213 is cached in the LUT cache area 144 (S408, Yes), or after the processing of S409, the management unit 152a determines whether the second table cache 145b related to the thread indicated by the AW ID included in the second update request (hereinafter referred to as the second table cache 145b of the target) is cached in the LUT cache area 144 or not (S410). In the processing of S410, the management unit 152a follows the pointer 210 from the second table cache 145a in order, so that the management unit 152a searches the second table cache 145b in which the same AW ID 211 as the AW ID included in the second update request is recorded.

In a case where the second table cache 145b of the target is determined not to be cached in the LUT cache area 144 (S410, No), the management unit 152a generates the second table cache 145b of the target by copying the second table cache 145a to the vacant area of the LUT cache area 144 (S411). “NULL” is recorded to the pointer 210 of the second table cache 145b of the target. The AW ID included in the second update request is recorded to the AW ID 211 of the second table cache 145b of the target.

After the processing of S411, the management unit 152a updates each pointer 210 constituting the list structure (S412). More specifically, for example, the management unit 152a overwrites the pointer 210 at the end of the list structure with the address indicating the storage location of the second table cache 145b of the target. In a case where the second table cache 145b of the target is cached in the LUT cache area 144 (S410, Yes), or after the processing of S412, the management unit 152a updates the second table cache 145b of the target (S413). More specifically, the management unit 152a associates the new physical address included in the second update request with the logical address included in the second update request.

In a case where the second update request is not received (S407, No), or after the processing of S413, the management unit 152a determines whether the update determination request has been received or not (S414). When the update determination request is determined to have been received (S414, Yes), the management unit 152a reflects all the second table caches 145b including, as the AW ID 211, the AW ID included in the update determination request respectively in the second table cache 145a (S415).

A specific example of the processing of S415 will be hereinafter explained. The management unit 152a gives an attention to a second table cache 145b including, as the AW ID 211, the AW ID included in the update determination request. The management unit 152a classifies the entries of the attention-given second table cache 145b into entries that have been updated since the attention-given second table cache 145b is generated and entries that have not yet been updated since the attention-given second table cache 145b is generated. The management unit 152a writes a value recorded in the second table cache 145a of the copy source to the entry that has not yet been updated in an overwriting format. The management unit 152a records NULL to the AW ID 211 of the attention-given second table cache 145b, and updates the first table cache 143 so as to indicate the attention-given second table cache 145b. Therefore, the attention-given second table cache 145b is thereafter treated as the second table cache 145a. The original second table cache 145a is, for example, deleted. The management unit 152a updates each pointer 210 constituting the list structure. The management unit 152a gives attention to all of the second table caches 145b including, as the AW ID 211, the AW ID included in the update determination request, and executes the above series of processing on each of the attention-given second table caches 145b.

After the processing of S415, the management unit 152a sets, as dirty, all the second table caches 145a which are the targets of the processing of S415 (S416). In addition, in the first table cache 143, all the entries indicating the storage locations of the second table caches 145a which are the targets of the processing of S415 are set as dirty (S417).

In a case where the update determination request is not received (S414, No), or after the processing of S417, the management unit 152a determines whether the translation request has been received or not (S418). In a case where the translation request is determined to have been received (S418, Yes), the management unit 152a determines whether the second table 1213 of the logical address included in the translation request is cached in the LUT cache area 144 or not (S419). In a case where the second table 1213 is determined not to be cached in the LUT cache area 144 (S419, No), the management unit 152a reads the second table 1213 as the second table cache 145a to the LUT cache area 144 (S420). The management unit 152a records “NULL” to the pointer 210 and the AW ID 211 of the second table cache 145a. In a case where the second table 1213 is cached in the LUT cache area 144 (S419, Yes), or after the processing of S420, the management unit 152a translates the logical address included in the translation request on the basis of the second table cache 145a into the physical address (S421). The management unit 152a returns the physical address obtained from the translation back to the data processing unit 151a. In a case where the translation request is determined not to have been received (S418, No), or after the processing of S421, the management unit 152a executes the processing of S401 again.

As described above, in the second embodiment, the management unit 152a generates the second table cache 145b by copying the second table cache 145a. When the user data which are requested to be written by the write command of the atomic write mode are written to the NAND memory 12, the management unit 152a uses the second table cache 145b. In a case where the atomic write mode is terminated, the management unit 152a reflects the second table cache 145b in the second table cache 145a. Before the thread is terminated, the second table cache 145a is not updated in the processing of the write command of the atomic write mode, and therefore, in a case where the thread is interrupted, and there exists user data which are requested to be written by the write command of the interrupted thread and have already been written to the NAND memory 12, the physical address indicating the storage location of the user data is in the state of not being associated with the logical address by the second table cache 145a. Therefore, even if the second table cache 145a at the time when the thread is interrupted is restored, the state of the restored second table cache 145a is in such state that the thread is not started, and therefore, the operation of the atomic write is realized. It should be noted that the management unit 152a executes reflection of the second table cache 145b to the second table cache 145a in accordance with the reception of the update determination request. The data processing unit 151a transmits the update determination request to the management unit 152a after the second update request is transmitted to all the write data which are requested to be written by the write commands of the thread identified by the AW ID included in an end command after the reception of the end command. More specifically, a case where the atomic write mode is terminated includes a case after the timing when at least the end command is received. The case where the atomic write mode is terminated includes a case after an end command is received and the second update request is transmitted for all the write data which are requested to be written by the write commands of the thread identified by the AW ID included in the end command.

It should be noted that, in a case where the data processing unit 151 queues the update requests before the thread is terminated and the management unit 152 executes all the queued update requests when the thread is terminated, the management unit 152 needs to access the translation information for each update request. In contrast, according to the second embodiment, when the thread is terminated, the management unit 152a executes reflection of the translation information in units of regions, and therefore, the update of the translation information can be completed in a shorter time when the thread is terminated.

When the management unit 152a reads, from the NAND memory 12, the user data 1221 requested to be read by the read command, the management unit 152a uses the second table cache 145a. Therefore, even when the thread is being executed, the reading of the user data 1221 from the NAND memory 12 can be executed on the basis of the translation information in the state in which the thread is not started.

The management unit 152a uses the second table cache 145a when the user data which are requested to be written by a write command other than the atomic write mode are written to the NAND memory 12. Therefore, even when the thread is being executed, the writing of the user data to the NAND memory 12 can be executed on the basis of the translation information in the state in which the thread is not started.

It should be noted that the management unit 152a reflects the second table cache 145b in the second table cache 145a in accordance with the reception of the end command. The second table cache 145b is reflected in the second table cache 145a after the thread is terminated, and therefore, the memory system 1 is maintained in the state in which none of the user data requested to be written by the write command of the thread is written before the thread is terminated, and all the user data which are requested to be written by the write commands of the thread transit to the written state after the thread is terminated. More specifically, the operation of the atomic write is realized.

The management unit 152a updates the second table cache 145b in accordance with the writing, to the NAND memory 12, of the user data which are finally requested to be written from among one or more user data which are requested to be written by the write command of the thread, and thereafter, reflects the second table cache 145b in the second table cache 145a.

The data processing unit 151a can receive write commands of multiple threads in parallel. The management unit 152a generates the second table cache 145b for each thread. Therefore, the memory system 1a can realize the operation of the atomic write for multiple threads.

The end command includes identification information for identifying a corresponding thread. Therefore, the memory system 1 can identify the thread to be terminated on the basis of the identification information included in the end command.

The size of the logical address space provided by the memory system 1 to the outside is referred to as a user capacity. The user capacity of the memory system 1 is less than the capacity of the area to which the user data 1221 can be written (i.e., the user data area 122). The user data 1221 of which storage location is associated with the logical address by the translation information and the user data 1221 of which storage location is not associated with the logical address by the translation information are stored in the user data area 122. The capacity obtained by subtracting the user capacity from the capacity of the user data area 122 is called an over-provisioning capacity. The user data area 122 can accumulate, up to the over-provisioning capacity, the user data 1221 of which storage locations are not associated with the logical address by the translation information. In the first embodiment, the total capacity of the user data that can be received from the host 2 by all the threads during the processing cannot be more than the over-provisioning capacity. In other words, the total size that the data processing unit 151a can receive from the user data at the start of the thread of the user data to the first data at the end of the thread is equal to or less than the over-provisioning capacity of the memory system 1a.

### Third Embodiment

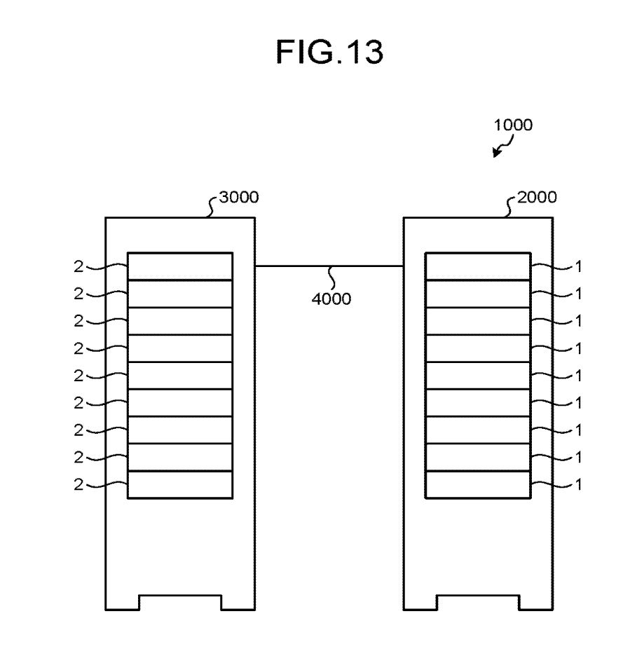

FIG. 13 is a figure illustrating an example of an implementation of a memory system 1. The memory system 1 is implemented in, for example, a server system 1000. The server system 1000 is configured by connecting a disk array 2000 and a rack mount server 3000 with a communication interface 4000. Any given standard can be employed as the standard of the communication interface 4000. The rack mount server 3000 is configured by mounting one or more hosts 2 on the server rack. Multiple hosts 2 can access the disk array 2000 via the communication interface 4000.

The disk array 2000 is configured by mounting one or more memory systems 1 on the server rack. Not only the memory system 1 but also one or more hard disk units may be mounted on the disk array 2000. Each memory system 1 can execute a command from each host 2. Each memory system 1 has a configuration in which the first or second embodiment is employed. Therefore, each memory system 1 can easily execute the atomic write.

In the disk array 2000, for example, each memory system 1 may be used as a cache of one or more hard disk units. A storage controller unit for structuring RAID by using one or more memory systems 1 may be mounted on the disk array 2000.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system connectable to a host, comprising:
a nonvolatile memory; and
a controller executes data transfer between the host and the memory in response to a command from the host and manages first translation information indicating a relation between logical location information and physical location information, the logical location information being location information designated from the host, the physical location information being location information indicating a physical location in the memory,
wherein in a case where the controller stores first data to the memory, the controller updates second translation information, and the first data is included in a data group received from the host in a first write mode, and the second translation information is a copy of the first translation information, and
in a case where the first write mode is terminated, controller reflects the second translation information in the first translation information.

2. The memory system according to claim 1, wherein in a case where the controller executes data transfer from the memory to the host, the controller obtains physical location information with respect to a data transfer destination in the memory by referring to the first translation information.

3. The memory system according to claim 2, wherein in a case where the controller stores second data to the memory, the controller updates the first translation information, and the second data is data received from the host in a second write mode different from the first write mode.

4. The memory system according to claim 1, wherein the controller receives an end command, and reflects the second translation information in the first translation information in response to reception of the end command.

5. The memory system according to claim 4, wherein the controller reflects the second translation information in the first translation information after the end command is received and after the second translation information is updated with respect to last first data of the data group.

6. The memory system according to claim 1, wherein the controller receives a plurality of the data groups in parallel, and generates the second translation information for each data group.

7. The memory system according to claim 6, wherein the controller receives an end command for each data group, and reflects second translation information of a data group corresponding to the received end command in the first translation information.

8. The memory system according to claim 7, wherein the controller updates the second translation information of the data group corresponding to the received end command in accordance with last first data of the data group corresponding to the received end command, and thereafter, reflects the second translation information related to a data group corresponding to the received end command in the first translation information.

9. The memory system according to claim 8, wherein the end command includes identification information for identifying a corresponding data group.

10. The memory system according to claim 1, wherein a total size of the first data which the controller is capable of receiving from a start of the data group to an end of the data group is equal to or less than an over-provisioning capacity of the memory system.
